(19) United States
(12) Patent Application Publication
(10) Pub. No.: US 2017/0344204 A1
(43) Pub. Date: Nov. 30, 2017

(54) SYSTEMS AND METHODS FOR DETECTING AND DISPLAYING GRAPHIC CONTENTS ON DIGITAL MEDIA PAGE

(71) Applicant: Apple Inc., Cupertino, CA (US)

(72) Inventors: Jaden M. GELLER, Folsom, CA (US); Allison M. STYER, San Francisco, CA (US); Charles J. MIGOS, Millbrae, CA (US); Casey M. DOUGHERTY, San Francisco, CA (US)

(21) Appl. No.: 15/243,795

(22) Filed: Aug. 22, 2016

Related U.S. Application Data
(60) Provisional application No. 62/217,013, filed on Sep. 10, 2015.

(51) Int. Cl. G06F 3/0483; G06F 17/21

(52) U.S. Cl. CPC G06F 3/0483; G06F 17/212

(57) ABSTRACT

A method for detecting content on a page of digital media that has a reading direction by reading image data beginning from a starting point in the reading direction of the digital media and identifying the content by analyzing differences in the image data as the image data is read. The method can include mapping a boundary of the content based on variations between content image data and surrounding background image data and generating a content map for the page using the boundary of the content, where the content map allows the page to be navigated between multiple pieces of content.

### CROSS-REFERENCE TO RELATED APPLICATIONS

The present application claims the benefit of U.S. Provisional Application No. 62/217,013, entitled “SYSTEMS AND METHODS FOR DETECTING AND DISPLAYING GRAPHIC CONTENTS ON DIGITAL MEDIA PAGE” filed Sep. 10, 2015, the content of which is incorporated herein by reference in its entirety for all purposes.

### FIELD

The present disclosure relates generally to applications for viewing images on a computing device. More specifically, the present embodiments relate to authoring tools for organizing content on a page for viewing at the computing device.

### BACKGROUND

The prevalence of portable computing devices has lead to the popularity of digital media that can be accessed from almost anywhere at anytime. Some forms of digital media include digital books that include text and images. When viewed on an electronic device, and in particular portable electronic devices, some digital books can be tedious for a user to navigate through, because of the organization of the images in the digital books. For example, a user may be required to manually navigate through and center certain images without any assistance from the portable device. As a result, the user may spend more time thinking about how to position the images than absorbing the material they are viewing.

### SUMMARY

This paper describes various embodiments that relate to methods and systems for displaying and navigating contents on an electronic device and in some embodiments to defining contents for the display and navigation on an electronic device.

Some embodiments can include a method for detecting content on a page of digital media that has a reading direction by reading image data beginning from a starting point in the reading direction of the digital media and identifying the content by analyzing differences in the image data as the image data is read. The method can include mapping a boundary of the content based on variations between content image data and surrounding background image data and generating a content map for the page using the boundary of the content, where the content map allows the page to be navigated between multiple pieces of content.

In some embodiments the starting point can be the first point on the page based on a reading direction of the digital media. In some embodiments the starting point can be at the top left corner of the page and the reading direction can be left to right from top to bottom. In some embodiments the starting point can be at the top right corner of the page and the reading direction can be right to left from top to bottom. Some embodiments can include accessing metadata associated with the page for the reading direction. In some embodiments the page can include multiple pieces of content, and the method can further include identifying multiple boundaries of the multiple pieces of content. In some embodiments the content can include text and images.

In some embodiments identifying the boundary of the content can include detecting at least two regions corresponding to separate content and calculating a confidence metric for determining that the separate contents will be treated as having two separate boundaries. In some embodiments identifying the boundary of the content can include detecting at least two regions corresponding to the panel and calculating a confidence metric for determining that the content will be treated as having a single boundary despite the detecting of the at least two content regions.

Some embodiments can include generating the content map includes creating a sequential order of multiple pieces of content of the page in accordance with the reading direction based on how the multiple pieces of content are arranged relative to each other.

Some embodiments can include a computing device including a network connection that can receive digital media data that includes a content and a background surrounding the content and a processor that can characterize a boundary of the content by determining differences between the content and the background and generate a content map based on the boundary. The computing device can include a user interface that can display the page in accordance with the content map.

Some embodiments can include a storage device that can store metadata for identifying a reading order for the content map. In some embodiments the digital media data can be a comic book and the content can include graphical panels comprising text and images. In some embodiments the background can cover an area between two pieces of content and the processor can differentiate between the background and boundaries of the two pieces of content based on a confidence metric. In some embodiments the processor can differentiate between two partially overlapping pieces of content and characterize a boundary of each of the two partially overlapping pieces of content. Some embodiments can determine a sequential order for the content map based on a location of the one piece of content relative to another piece of content.

Some embodiments can include a method for generating a panel mapping for navigating a content panel of a page of a digital book to be displayed at a device generating a layout for the page that is configured to be displayed at a display device and receiving input identifying a location, size and shape of the content panel of the page. The method can include generating the panel mapping for the page using the location, size and shape of the content panel. In some embodiments the digital book can include multiple pages, each page includes multiple graphics panels, and the method can further include receiving input identifying the location, size and shape for the multiple content panels.

Some embodiments can include receiving input identifying a sequential order of the multiple graphics panels to be used when the multiple graphics panels are navigated. In some embodiments the digital book can be a comic book.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings.

FIG. 1 shows a diagram for creating, distributing and displaying digital media such as a comic book in accordance with some embodiments.

FIG. 2 shows an electronic device displaying a digital media page with content panels in accordance with some embodiments.

FIG. 3 shows an exemplary English language reading direction for the digital media page of FIG. 2 in accordance with some embodiments.

FIG. 4 shows a digital media page being read in the reading direction of FIG. 3 in accordance with some embodiments.

FIG. 5 shows a mask content map that can be provided with some digital media in accordance with some embodiments.

FIG. 6 shows a flow diagram of a method for detecting and/or creating a content map in accordance with some embodiments.

FIG. 7 shows flow diagram of a method for detecting content on a page in accordance with some embodiments.

FIG. 8 is a block diagram of a computing device that can represent the components of the electronic device in accordance with some embodiments.

### DETAILED DESCRIPTION

Representative applications of methods and devices according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Comic books, and similar media, are primarily graphic based, having graphics panels that are read in a particular order to follow the sequence of the story. Typically, comic books are read starting at the top and moving left to right when the comic is in English, or right to left when in Japanese. Reading comics on a digital device is done in much the same way. That said, some digital devices, depending on the screen size, can make viewing the particular panels difficult when a whole page is displayed on a smartphone display, for instance. Zooming in and out and moving around on a page is sometimes possible, but the interaction experience is cumbersome. Navigating around the page to view the comic book panels by manually manipulating the page while reading, feels unnatural leaving much to be desired in the way of a user experience. While comic books are mostly graphic, they usually contain text within the panels. The text itself can often be stylized to coordinate with the graphically focused storytelling theme of a comic. Even displaying the text in a zoomed manner can leave much to be desired. The embodiments described herein ameliorate many of these problems and provide an enriched user experience to users when viewing digital media on electronic devices.

Described embodiments generally relate to methods and systems for detecting content in digital media for displaying and navigating the content on an electronic device. Some embodiments relate to displaying the contents on a portable electronic device such as a tablet or smartphone, smart watch or other similar device. More specifically, embodiments described herein can use content mapping to isolate content on a page to be displayed prominently for viewing and navigation. The content mapping can be pre-defined by an author or publisher or the like. Alternatively, contents can be auto-detected and a content map can be generated.

Embodiments using content mapping can display a particular panel in a more prominent manner, such as enlarged and isolated, on the screen of an electronic device so it is easier to see. The graphics panel can be displayed in response to an input received from a user. The graphics panel can also be displayed automatically, for instance as a first panel in a comic book when beginning navigation of the book. Displaying the content in an isolated enlarged state is particularly useful in small portable electronic devices such as smartphones, but can be beneficial on all electronic devices for a better viewing experience. Once the content is more prominently displayed, navigation can be performed, from input by a user, or automatically, along the natural progression of the contents on the page. Navigation can also proceed to any other content on a page, as dictated by the input of the user. Various types of input can lead to any number of ways of navigating around the contents of a page or even back to the entire page as a whole.

In some embodiments, content can be zoomed in on and/or shown in darker, bolder, display resolution than its surroundings. In some embodiments, when a panel is enlarged or zoomed in on, the panel can fill the entire display along its width from left to right. In some cases the panel will not necessarily fill the display form top to bottom but the background area surrounding the panel can fill the rest of the display. In some embodiments, the content can be further enlarged in response to a user input and the content can fill the display from top to bottom. Depending on the configuration of the content, the display can crop part of the content. In this case the content can be moved left to right, by a user input such as a finger moving on a touch screen, to move all areas of the content around to be seen within the display screen.

In some embodiments the background can include contents adjacent the selected content and the adjacent elements can be shown in a muted, blurred and/or lightened state, for example, using a filter, mask or other method. This can be used to fade the adjacent elements and the rest of the page, seemingly into the background, thus more prominently displaying the selected content.

Regarding navigation, embodiments can utilize input from a user of an electronic device to control navigation between a selected panel and other panels of a comic book page, for example. Navigation from panel to panel can proceed as if a reader were reading the comic story from beginning to end. Embodiments can also allow for navigation to a previous panel or any panel or content on the page in response to input from the device user. In some embodiments, swipe gestures, left and right for example, which are just one form of input from a user that can be utilized, can be used for single-panel navigation forward or backward. Specific-panel gestures can provide input for controlling the direction and speed of navigation, corresponding to the direction and speed of the gesture. For example, swipe gestures that are quick and predominantly horizontal can be treated as single-panel navigation gestures that either advance or move backwards one panel. On the other hand, slower gestures with the non-horizontal direction can be treated as gestures selecting a specific panel (e.g., the panel on which the input is centered when the user finishes the gesture). Displaying the faded non-selected panels of the page around a selected panel can enable these gestural movements. Transition effects can be used in some embodiments, such as when navigating from one panel to the next, the first panel can appear to zoom out as the screen pans toward the next panel, which sequentially zooms into view, providing a dynamic user experience. Various other inputs, navigation modes and transitions are also possible.

In some embodiments distributors of digital media, such as publishers, authors and the like, can denote the panels and contents on a page. Some comic books and other media, which may have more obscure contents beyond simple panels, such as in the case of Manga, may benefit from pre-defining the contents to ensure an accurate mapping of the comic panels on a page. Since some panels may be irregularly shaped and overlap part of the other panels and “background” panels might not even have clear boundaries, the contents can be more difficult to auto-detect. Thus, in some embodiments, masks denoting the contents on a page (from an image-editing application for example) can be utilized. These pre-defined masks can be translated into coordinates for displaying the electronic digital media on an electronic display, by using an electronic publishing specification such as the ePub specification.

When pre-defining contents, the author or publisher can also identify panels for alpha feathering, and in some embodiments can apply such an effect around the panel. This means that, when selected, a transition area around the panel will not be fully part of the background. That is, the panel can be displayed with full color, the background can be displayed with a full filter, and the transition region around the selected panel can blend into the background with an alpha gradient. Also, the authors or publishers, in some embodiments, can specify a navigation order through the panels. For example, rather than always using a reading order such as left-to-right/top-to-bottom order, some embodiments can allow the authors or publishers to order the panels on a page in any desired order (for example clockwise). In some embodiments, the authors or publishers can reorder the panels by creating a list or use of a special tool to draw the order (for example with arrows) on a layout of the page.

Some embodiments can auto-detect contents on a page. Some embodiments can read image date on a page pixel to pixel in a reading direction to an end point determining content versus background using threshold or other manner and logging this data. Some embodiments can use a flood-fill algorithm on the page, stopping the fill at boundaries where the pixels change. The regions that are not filled can be the auto-detected panels, in the case of comics. Some embodiments can use other features, such as detecting when two or more regions are nearly separated, and applying confidence metrics to determine whether two regions should be separate panels. Some embodiments can automatically determine an order of the panels on the page by analyzing the panel locations. For instance, when a panel is detected to be closer to the top of a page or more to the left or right (depending on the reading order of the page) the panel can be prioritized in the reading progression order.

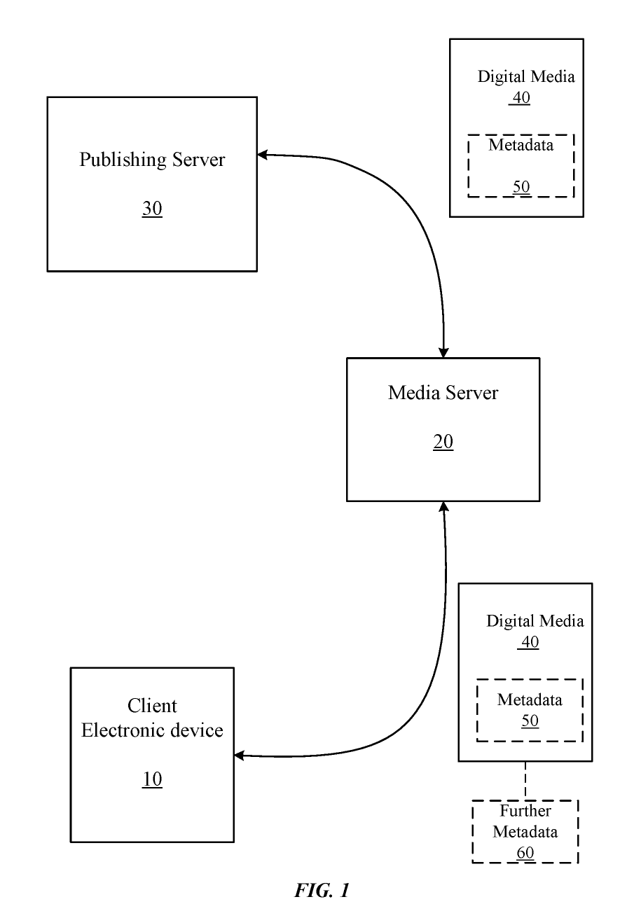

These and other embodiments are discussed below with reference to FIGS. 1-8; however, those skilled in the art will readily appreciate that the detailed description given herein with respect to these figures is for explanatory purposes only and should not be construed as limiting.

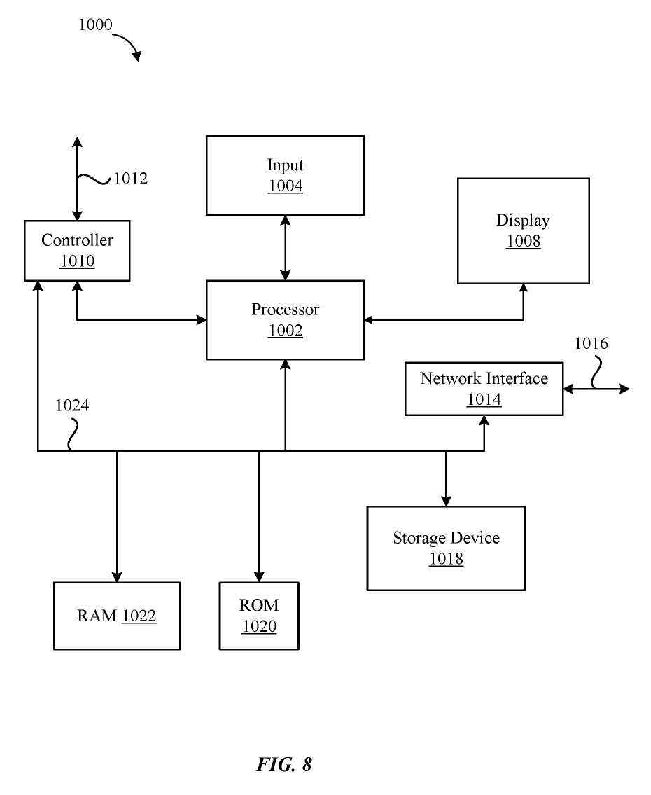

FIG. 1 shows a system for creating, distributing and displaying digital media 40. Digital media 40 can be created and stored on a publishing server 30 maintained by a publisher or author of digital media 40. Digital media 40 can take many forms such as comic books, recipe books, photo albums and other graphic intensive media. Publishing server 30 can be connected to a media server 20 for distributing digital media 40 to consumers. Media server 20 can include various distribution forms such as selling, licensing or renting and so on. Media server 20 can have a storefront for consumers to access for previewing, viewing and obtaining digital media 40. Media server 20 can have an applications store for providing an application for displaying the media as well as facilitating the ability to purchase digital media if applicable. Media server 20 can facilitate financial transactions for such purchases. Access to media server 20 and digital media 40, via the applications store for example, can be done by an electronic client device 10. Electronic client device 10 can take many forms such as a tablet, smartphone, watch, desktop computer, smart television and so on. The configuration of electronic device 10 is discussed in greater detail below with regard to FIG. 8.

Media server 20 can be configured to perform the method of some embodiments discussed herein. Specifically, embodiments with regard to auto-detection of content in digital media 20 can be performed at media server 20. Embodiments for auto-detection can also be performed at electronic client device 10 and/or at publishing server 30. Metadata 50 can accompany digital media 40. Metadata 50 can be generated at any of publishing server 30, media server 20 and/or electronic client device 10. In the illustrated embodiment metadata 50 can be in the form of content mapping prepared by the publisher or author that is associated with digital media 20. Digital media can be transmitted to media server 20 with metadata 50. Media server can perform methods in accordance with described embodiments and utilize metadata 50 and/or generate additional metadata 60. Additional metadata 60 can also be generated by electronic client device 10.

By way of example, a publisher might provide digital media 40 with a content map providing size, shape and location of the content in digital media 40. The publisher may not however provide any information on a navigation sequence in the content map. Media server 20 can perform the method in accordance with some embodiments described and auto-determine the navigation sequence from the size shape and location of the content as dictated by the content map and the language of digital media, such as English, which can also be included in metadata 50. The method for determining the navigation sequence can result in additional metadata 60 that can be associated with digital media 20. Digital media 20 with both metadata 50 and additional metadata 60 can be transmitted to electronic client device 10 for displaying digital media 40 to a consumer in an enriched user experience in accordance with some embodiments described herein.

Alternatively, a publisher may not provide any content information at all and only an image file of each page of digital media 40 is available. Then Media server and/or electronic client device 10 can perform the method of some embodiments and auto detect the content in digital media 40 and then associate this information with digital media 40. At this point digital media with the associated metadata 60 having the content map can be communicated between publishing server, media server and/or electronic client device 10 as the circumstance permits.

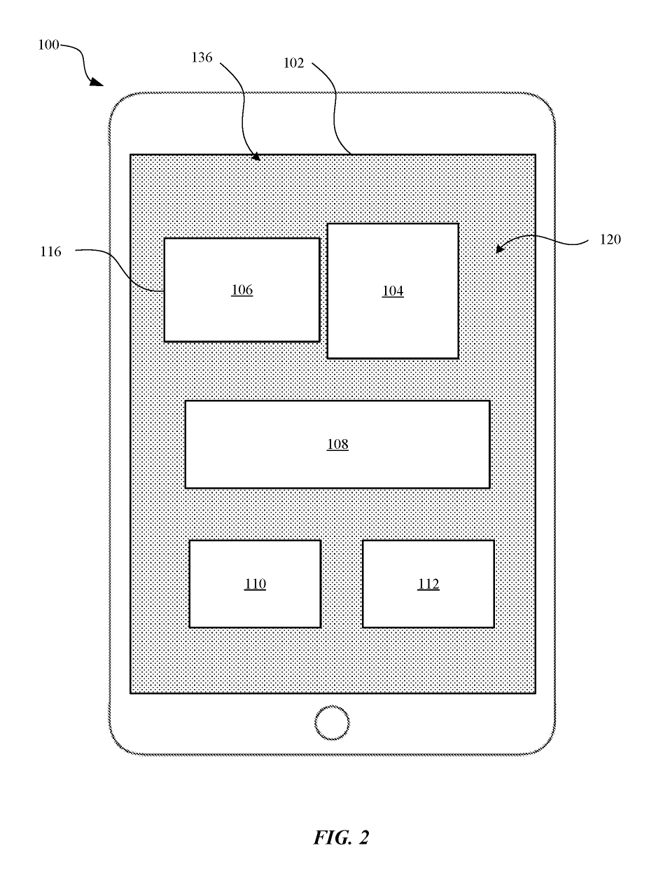

FIG. 2 shows an electronic device 100 having a display screen 102 for viewing a page 136 having content on electronic device 100. Display 102, can be a touchscreen interface that can communicate with a processor, shown in FIG. 8 and described further below. Display 102 can display digital media content such as comic books for viewing by a user. Content 106, 104, 108, 110 and 112, are illustrated as being displayed on page 136 displayed on display 102 and can take the form of panels or any other shape or configuration envisioned by an author as is common in comic books and similar digital media. A background 120 can surround content 106, 104, 108, 110 and 112. Background 120 is shown as uniform here, but can take many forms and can be solid, have a gradient appearance, or include graphics renditions, tonal and/or color variations, among numerous other options. Content 106, 104, 108, 110 and 112 combined with background 120 can make up a page (136). Digital media 40 can consist of one or multiple pages. Each page, as illustrated can have multiple pieces of content and/or a single piece of content. Content 106, 104, 108, 110 and 112 can overlap in some configurations and can have a boarder 116 for each respective panel. Since there are many different display sizes and resolutions of electronic devices and digital media, page sizes do not necessarily correlate to the proportions of all screens, in some embodiments, background 120 can be expanded to the edges of display 102 to ensure the display is always filled, even when the page itself would otherwise not entirely fill the screen.

In some embodiments page 136 can be a simple image file such as a JPEG or similar file and the location, size and shape of content 106, 104, 108, 110 and 112 in the image file is not a part of the page data. This makes it so that initially the image can only be displayed as a whole but only in a two-dimensional static way and content cannot be selectively displayed or navigated. To allow for selectively displaying and navigating the content of digital media in a dynamic manner, the location, size and shape of content 106, 104, 108, 110 and 112 needs to be mapped so electronic device 100 can display the content accordingly. A content map can be created in accordance with some embodiments either by auto-detecting the location, size and shape of content 106, 104, 108, 110 and 112 or by an author or publisher providing a content map with this information.

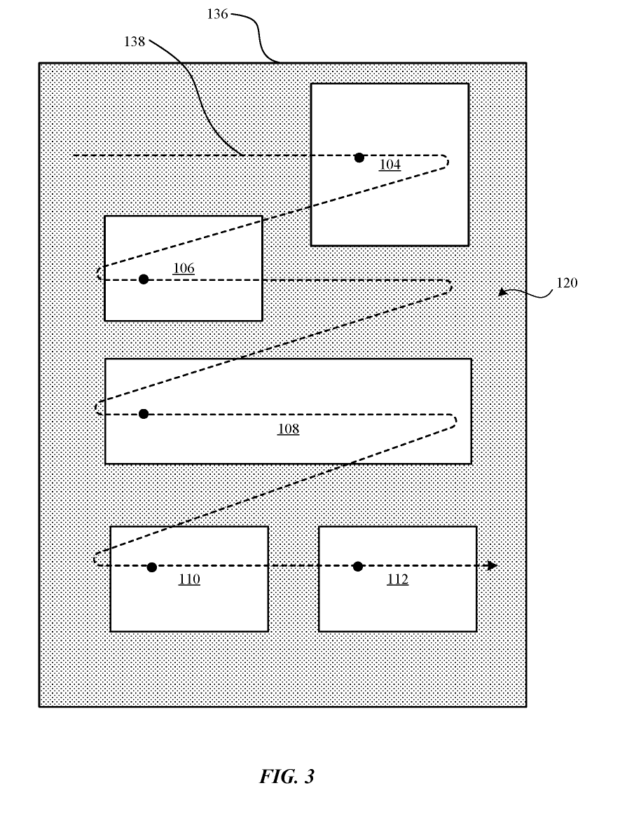

In the case of auto-detection, page 136 and/or digital media 40 can be scanned in a reading direction that can conform with the language of the digital media. FIG. 3 shows an exemplary English language reading direction for page 136 of FIG. 2. English language comic books, are read starting at the top traveling left to right and moving down the page. Reading path 138 shows this natural reading order. In this embodiment, the order of the content would be 104, 106, 108, 110 and then 112. Content 104 is the first content panel since content 104 is closest to the top of the page.

Scanning page 136 can be done in any number of ways by analyzing the image data of page 136 and detecting a boundary of each piece of content. In some embodiments this can be accomplished by using a flood-fill algorithm on the page, stopping the fill at boundaries where the pixels change. The regions that are not filled can be the auto-detected panels in the case of comics. Some embodiments can use additional features, such as detecting when two or more regions that are nearly separated, and applying confidence metrics to determine whether two regions should be separate panels. In some embodiments the page can be read in a reading direction by reading image data beginning from a starting point and identifying the content by analyzing differences in the image data as the image data is read. A content map can be generated by mapping a boundary of the content based on variations between content image data and surrounding background image data.

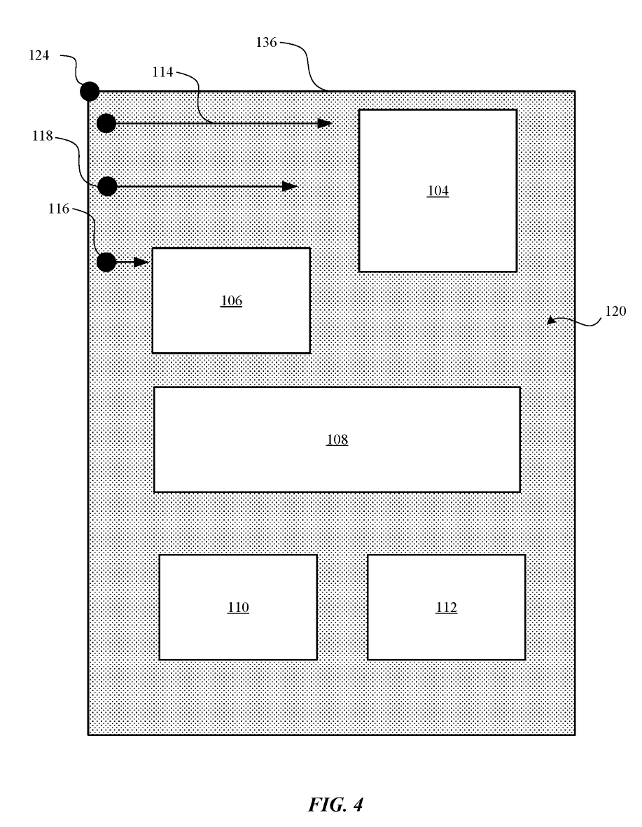

FIG. 4 shows a page 136 of digital media 40 being read in the reading direction of FIG. 3 in accordance with some embodiments. Starting point 124 is located in the upper left corner given the reading order of starting at the top and reading left to right while moving down. Reading can proceed as illustrated from left to right along a path 114 and upon reaching the edge of page 136, moving down and again scanning left to right along path 118, then path 116, and so on. The scanning can take the form of analyzing pixels that make up page 136 in the sequential order described. As the page 136 is scanned, the content is detected by identifying changes in pixels based on a predetermined threshold. Using the threshold, as the page is scanned it can be determined whether a particular pixel is that of background 120 or content such as content 104. As page 136 is scanned and each pixel is analyzed, a log can be kept of whether each pixel is a content pixel or a background pixel. After all of page 136 has been scanned a content map can be determined for page 136.

Given the scanning described, the reading order of the content can automatically be determined for the page by using the content locations as mapped. Thus, when content is detected to be closer to the top of page 136, such as content 104, or more to the left (or right depending on the reading order of the page) the content can be prioritized in the reading order.

While auto-detection of the content has been described, some embodiments, can include the ability for authors or publishers to either change the auto-detected mapping of the graphics panels, for instance to change story progression or even to modify graphics panels to be different than detected. Alternatively, some embodiments can include tools for authors or publishers to define the graphics panel mapping themselves. Navigation through the graphics panels as described above can use the auto-detected or pre-defined mapping to dictate the story progression and content layout for display on a screen.

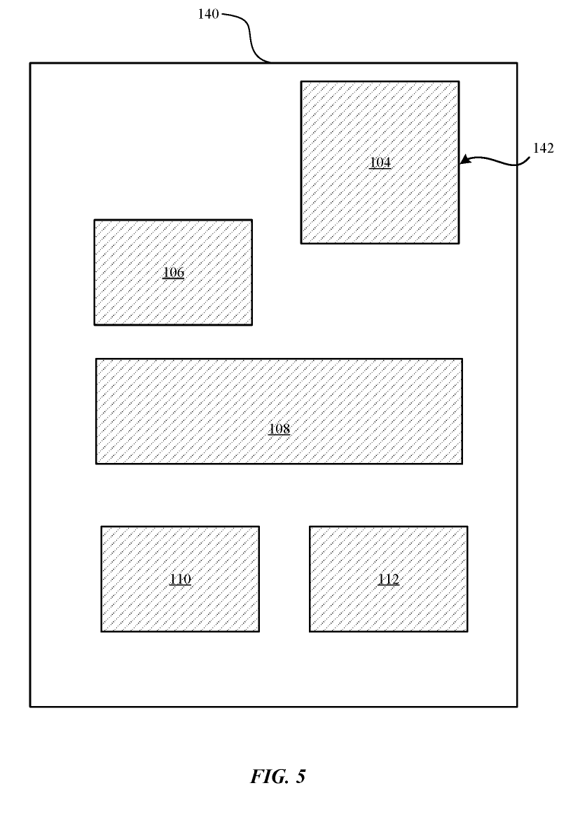

In some embodiments, the content is not detected and alternatively can be pre-defined by a publisher or an author. FIG. 5 shows a mask 140 that can correspond with the content layout of FIG. 2. The crosshatched masked out portions 142 correspond to the locations of the content of FIG. 2. An author or publisher can provide this layout with digital media 40, in a manner that can utilized with the ePub standard, for example. Embodiments can then use the mask to dictate the layout of the content for viewing and navigation purposes. Along with the mask, reading of the panels can be dictated by the author or publisher. For example if an author wants to have content read out of the ordinary reading order, they could provide a particular navigation order of the content by way of the content map that can be associated with the digital media, as metadata for example.

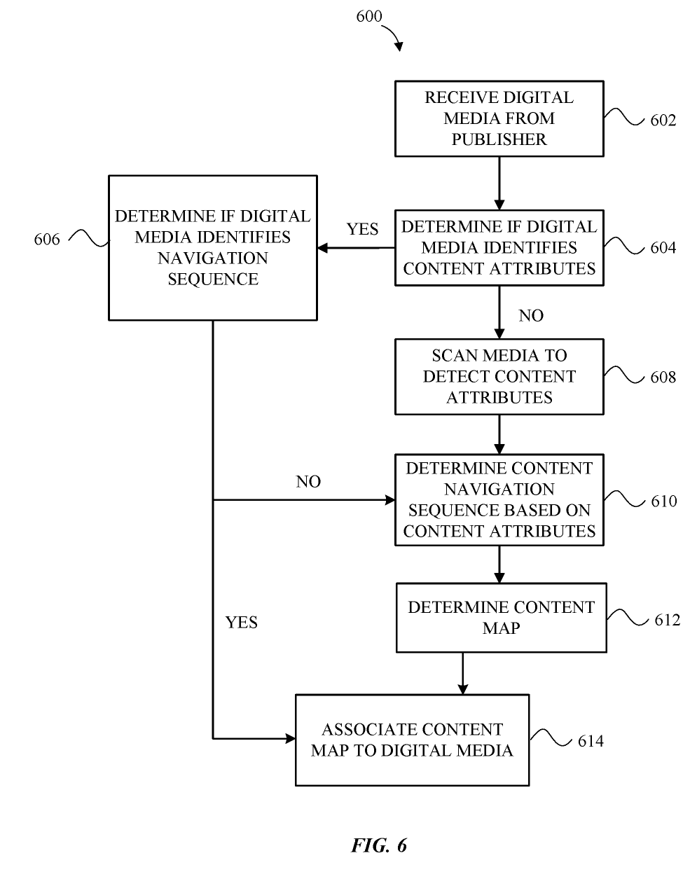

Referring back to FIG. 1, in some embodiments, media server 20 can receive digital media and will need to determine if metadata is provided with content mapping or if a content map will need to be generated using auto-detection. FIG. 6 shows a flow diagram of a method for detecting a content map and/or auto-detecting content in accordance with some embodiments. Method 600 can ensure a content map is provided for digital media 40 so that when it is displayed at electronic device 10, the content can be displayed in an interactive manner. Method 600 first receives digital media 40 from publishing server 30 in step 602. Then in step 604 it is determined if digital media 40 has any content attributes which can include location, size and shape of the content in the form of a content map. If content attributes exist, it is determined if a content navigation sequence also exist in step 606. If a content navigation sequence exists, the process recognizes that information provided with digital media 40 provides the information necessary to display and navigate digital media 40 and thus does nothing (i.e. it maintains the association of the content map with digital media 40).

On the other hand if at step 606, content attributes are not detected, then in a step 608 digital media 40 can be scanned to detect the size, shape and location of the content. Since content attributes were not detected, but now have been, in a next step 610 the content navigation sequence can be detected based on the content attributes. Determining the navigation sequence can be based on the reading order of digital media 40 as well as either the provided content attributes as determined in step 604 or as detected in step 608. Note that if in step 604 it is determined that content attributes are detected, but then in step 606 it is determined that a navigation sequence is not detected, then in step 610, a navigation sequence can be determined from the provided content attributes. Once the navigation and content attributes are determined a content map can be determined in a step 612. Then in a step 614 the content map can be associated with digital media for displaying and navigating digital media 40 on electronic device 10.

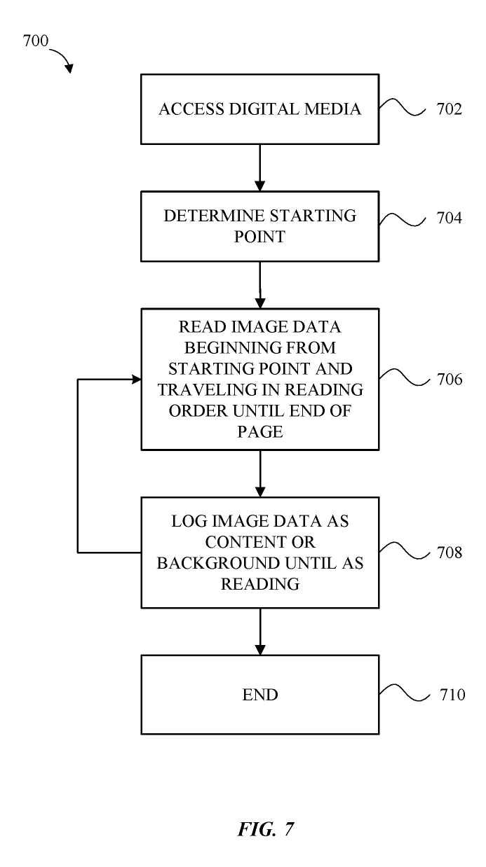

FIG. 7 shows a method 700 for reading image data to auto-detect content on a page of digital media. In a first step 702 the digital media is accessed. In a subsequent step 704, information about the reading order of the digital media is determined. This can be obtained from metadata provided with the digital media of by input by a user if necessary among other means. Once the reading order is determined, the starting point can be determined in a step 704 and is the first point on the page of the digital media in accordance with the reading order. In step 706 the image data is read beginning at the starting point. In some embodiments, the image data can be read pixel by pixel in the reading order. As the pixels are read the information is logged in a step 708. The information read can log location as well whether a pixel is content or background. Determining whether each pixel is content or background can be done according to various methods including using a threshold value and/or confidence matrices among other methods. The process continues with step 706 and 708 for each pixel in reading and logging the data until reaching the end of the page where the process ends in step 710 after logging the last data information. Process 700 can be repeated for each page in a digital media, when there are multiple pages, to detect all the content in digital media.

Logging the image data can be used for creating the content map that includes the boundaries, location and navigation sequence of the content. This can then be used for displaying and navigation of the graphics panels on an electronic device.

FIG. 9 shows is a block diagram of a computing device 1000 that can represent the components of the electronic device 100. It will be appreciated that the components, devices or elements illustrated in and described with respect to FIG. 9 may not be mandatory and thus some may be omitted in certain embodiments. The computing device 1000 can include a processor 1002 that represents a microprocessor, a coprocessor, circuitry and/or a controller for controlling the overall operation of computing device 1000. Although illustrated as a single processor, it can be appreciated that the processor 1002 can include a plurality of processors. The plurality of processors can be in operative communication with each other and can be collectively configured to perform one or more functionalities of the computing device 1000 as described herein. In some embodiments, the processor 1002 can be configured to execute instructions that can be stored at the computing device 1000 and/or that can be otherwise accessible to the processor 1002. As such, whether configured by hardware or by a combination of hardware and software, the processor 1002 can be capable of performing operations and actions in accordance with embodiments described herein.

The computing device 1000 can also include user input device 1004 that allows a user of the computing device 1000 to interact with the computing device 1000. For example, user input device 1004 can take a variety of forms, such as a button, keypad, dial, touch screen, audio input interface, visual/image capture input interface, input in the form of sensor data, etc. Still further, the computing device 1000 can include a display 1008 (screen display) that can be controlled by processor 1002 to display information to a user. Controller 1010 can be used to interface with and control different equipment through equipment control bus 1012. The computing device 1000 can also include a network/bus interface 1014 that couples to data link 1016. Data link 1016 can allow the computing device 1000 to couple to a host computer or to accessory devices. The data link 1016 can be provided over a wired connection or a wireless connection. In the case of a wireless connection, network/bus interface 1014 can include a wireless transceiver.

The computing device 1000 can also include a storage device 1018, which can have a single disk or a plurality of disks (e.g., hard drives) and a storage management module that manages one or more partitions (also referred to herein as “logical volumes”) within the storage device 1018. In some embodiments, the storage device 1018 can include flash memory, semiconductor (solid state) memory or the like. Still further, the computing device 1000 can include Read-Only Memory (ROM) 1020 and Random Access Memory (RAM) 1022. The ROM 1020 can store programs, code, instructions, utilities or processes to be executed in a non-volatile manner. The RAM 1022 can provide volatile data storage, and store instructions related to components of the storage management module that are configured to carry out the various techniques described herein. The computing device 1000 can further include data bus 1024. Data bus 1024 can facilitate data and signal transfer between at least processor 1002, controller 1010, network interface 1014, storage device 1018, ROM 1020, and RAM 1022.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable storage medium. The computer readable storage medium can be any data storage device that can store data, which can thereafter be read by a computer system. Examples of the computer readable storage medium include read-only memory, random-access memory, CD-ROMs, HDDs, DVDs, magnetic tape, and optical data storage devices. The computer readable storage medium can also be distributed over network-coupled computer systems so that the computer readable code is stored and executed in a distributed fashion. In some embodiments, the computer readable storage medium can be non-transitory.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for detecting content on a page of digital media having a reading direction, the method comprising:
by a processor:
reading image data beginning from a starting point and in the reading direction of the digital media;
identifying the content by analyzing differences in the image data as the image data is read;
mapping a boundary of the content based on variations between content image data and surrounding background image data; and
generating a content map for the page using the boundary of the content, wherein the content map allows the page to be navigated between multiple pieces of content.

2. The method of claim 1, wherein the starting point is the first point on the page of the reading direction of the digital media.

3. The method of claim 2, wherein the starting point is at the top left corner of the page and the reading direction is left to right from top to bottom.

4. The method of claim 2, wherein the starting point is at the top right corner of the page and the reading direction is right to left from top to bottom.

5. The method of claim 1, further comprising:
accessing metadata associated with the page for the reading direction.

6. The method of claim 1, wherein the page includes multiple pieces of content, and the method further includes identifying multiple boundaries of the multiple pieces of content.

7. The method of claim 1, wherein the content includes text and images.

8. The method of claim 1, wherein identifying the boundary of the content includes (i) detecting at least two regions corresponding to separate content and (ii) calculating a confidence metric for determining that the separate contents will be treated as having two separate boundaries.

9. The method of claim 1, wherein identifying the boundary of the content includes (i) detecting at least two regions corresponding to the panel and (ii) calculating a confidence metric for determining that the content will be treated as having a single boundary despite the detecting of the at least two content regions.

10. The method of claim 1, wherein generating the content map includes creating a sequential order of multiple pieces of content of the page in accordance with the reading direction based on how the multiple pieces of content are arranged relative to each other.

11. A computing device comprising:
a network connection configured to receive digital media data that includes a content and a background surrounding the content;
a processor configured to (i) characterize a boundary of the content by determining differences between the content and the background, (ii) and generate a content map based on the boundary; and
a user interface configured to display the page in accordance with the content map.

12. The computing device of claim 11, further comprising:
a storage device configured to store metadata for identifying a reading order for the content map.

13. The computing device of claim 11, wherein the digital media data is a comic book and the content includes graphical panels comprising text and images.

14. The computing device of claim 11, wherein the background covers an area between two pieces of content and the processor is further configured to differentiate between the background and boundaries of the two pieces of content based on a confidence metric.

15. The computing device of claim 11, wherein the processor is further configured to differentiate between two partially overlapping pieces of content and characterize a boundary of each of the two partially overlapping pieces of content.

16. The computing device of claim 11, wherein the processor is further configured to determine a sequential order for the content map based on a location of the one piece of content relative to another piece of content.

17. A method for generating a panel mapping for navigating a content panel of a page of a digital book to be displayed at a device, the method comprising:
by a processor of the device:
generating a layout for the page that is configured to be displayed at a display device
receiving input identifying a location, size and shape of the content panel of the page; and
generating the panel mapping for the page using the location, size and shape of the content panel.

18. The method of claim 17, wherein the digital book comprises multiple pages, each page includes multiple content panels, and the method further include receiving input identifying the location, size and shape for the multiple content panels.

19. The method of claim 18, further comprising the step: receiving input identifying a sequential order of the multiple content panels to be used when the multiple content panels are navigated.

20. The method of claim 3, wherein the digital book is a comic book.
